(19) United States
(12) Patent Application Publication
(10) Pub. No.: US 2023/0076263 A1
(43) Pub. Date: Mar. 9, 2023

(54) AN ANTI-TAMPERING DEVICE

(71) Applicants: Vivien DE KLERK, Pretoria (ZA); Jacobus Petrus VENTER, Pretoria (ZA)

(72) Inventors: Vivien DE KLERK, Pretoria (ZA); Jacobus Petrus VENTER, Pretoria (ZA)

(21) Appl. No.: 17/904,405

(22) PCT Filed: Feb. 18, 2021
(86) PCT No.: PCT/ZA2021/050009

§ 371 Date: Aug. 17, 2022

(30) Foreign Application Priority Data
Feb. 18, 2020 (ZA) 2020/01005
Nov. 30, 2020 (ZA) 2020/07424

(51) Int. Cl. H01M 50/576; G08B 13/06; G08B 13/08; G08B 13/189; G08B 21/02

(52) U.S. Cl. CPC H01M 50/576; G08B 13/06; G08B 13/08; G08B 13/1895; G08B 21/0266; G08B 21/0283; H01M 2220/20

(57) ABSTRACT

A system for serving legal documents for initiating legal proceedings which includes a repository, the form of a database which is stored on a server (not shown), for receiving and storing legal documents for initiating legal proceedings, a notification means, in the form of a notifier, for notifying a recipient via an agreed digital address (not shown) of receipt by the database of a legal document, and a payment means (not shown) for allowing the recipient to access the legal document free of charge.

### TECHNICAL FIELD

This invention relates to an anti-tampering device for a cell arrangement.

### SUMMARY OF THE INVENTION

According to the invention, there is provided an anti-tampering device including:

a housing for housing a cell arrangement;

a sensor arrangement mounted on the housing for sensing tampering with the housing; and

a deterring means arranged in communication with the sensor arrangement and configured to activate when tampering is sensed by the sensor arrangement.

The housing may include a container portion and a lid portion for allowing the container portion to be closed. The container portion may be sized, shaped and/or configured to receive the cell arrangement complementally therein. The container portion may be sized, shaped and/or configured to house the sensor arrangement and/or deterring means therein. The lid portion may be displaceably secured to the housing via a hinge arrangement, screws, adhesive and/or a latch arrangement. Preferably, the lid portion may be in the form of a hinged cover which may be secured to the container portion via a lockable latch arrangement. The housing may be manufactured form any suitable plastics and/or metallics material.

The cell arrangement may include a plurality of cells which may be arranged in a series or parallel configuration to form a battery. The battery may be in the form of a lead acid battery or lithium battery. The cell arrangement may be capable of powering any electronic equipment, device or components which may be utilised in any one of the group including but not limited to a computing device, computing system, motored vehicle including a car, truck, motorbike and motorboat, and telecommunication instrumentation. In one form of the invention, the cell arrangement may be in the form of a battery capable of powering electronic equipment utilised in telecommunication instrumentation which may be mounted on telecommunication tower structures. In another form of the invention, the cell arrangement may be in the form of a battery for a motor vehicle. The battery may have any suitable voltage required for powering particular electronic equipment, devices or components, preferably being in the range of 2 to 48V, preferably varying according to the voltage requirement of the device to be powered.

The sensor arrangement may be mounted on the housing, preferably being mounted within the housing for sensing tampering therewith. The sensor arrangement may include any one or more of the group including a heat sensor for sensing heat applied to the housing, opening sensor for sensing opening of the housing, displacement sensor for sensing relative displacement of the housing, proximity sensor for sensing proximity of the housing relative a reference point, and motion sensor for sensing motion of an object within the housing. The sensor arrangement may be configured to activate the deterring means when tampering is sensed.

The heat sensor may be configured to sense heat which may be applied to the housing, typically heat applied in an attempt to compromise the structural integrity of the housing to facilitate removal and theft of the cell arrangement. The heat sensor may be arranged within the housing, preferably being mounted on an inner wall thereof.

The opening sensor may be configured to sense when the lid portion of the housing is opened and/or removed from the housing. The opening sensor may be located on the lid portion, preferably on an inner surface thereof, and/or on a wall and/or a base of the container portion of the housing, preferably an inner surface thereof. The opening sensor may be in the form of a light sensor for sensing light entering the housing, typically when the lid portion is opened and/or removed from the housing during daylight or when a lighting device, typically a torch or the like, is used to light up an inside of the housing during the night. The light sensor may be selected from the group including a photoresistor, photodiode, and phototransistor. Alternatively, the opening sensor may be in the form of a magnetic sensor arrangement which may be arranged on opposing abutting edge regions of the lid and container portions of the housing. In particular, the magnetic sensor arrangement may be configured to sense the absence of a magnetic field when the lid potion is opened and/or removed from the container portion of the housing. More particularly, the magnetic sensor arrangement may include a magnetic element and a magnetic sensor which may be arranged on the lid portion, preferably an inner edge region thereof, and/or on the wall and or base of the container portion of the housing, preferably an inner edge region thereof, respectively. The magnetic sensor may be selected from the group including a giant magnetoresistance (GMR) sensor, hall sensor, and reed switch.

The displacement sensor may be configured to sense displacement of the housing and/or cell arrangement relative a support surface, typically being a ground surface or base plate. The displacement sensor may be located on a surface of the housing, preferably an inner surface thereof, and/or a surface of the cell arrangement, preferably an outer surface thereof. The displacement sensor may be in the form of any one or more of the group including an accelerometer, gyroscope, magnetometer, impact sensor, shock sensor, and vibration sensor.

The proximity sensor may be configured to sense a proximity of the housing and/or cell arrangement relative to the reference point. The reference point may be defined by the location of the proximity sensor. Alternatively, the reference point may be defined by a surface sensed by the proximity sensor. The proximity sensor may be mounted on the housing and orientated to face and sense a particular surface in the vicinity of the housing. Alternatively, the proximity sensor may be mounted on a support surface in the vicinity of the housing and orientated to face and sense a surface of the housing. More particularly, the support surface may form part of any fixed surface located in the vicinity of the housing and/or cell arrangement. The support surface may form part of the telecommunication tower structure on which telecommunication instrumentation being powered by the cell arrangement is mounted. Alternatively, the support surface may form part of any component or structural element of a vehicle which may be located in the vicinity of the housing and/or cell arrangement. In particular, the proximity sensor may be configured to sense when a proximity of the housing and/or cell arrangement to the reference point exceeds a desired limit. The desired distance may be set according to the preferences of a user, typically being set according to the preferences of the telecommunication network service provider. The proximity sensor may be located on the surface of the housing, preferably the inner surface thereof, and/or surface of the cell arrangement, preferably the outer surface thereof. The proximity sensor may be in the form of any one or more of the group including a conductive proximity sensor, capacitive proximity sensor, ultrasonic proximity sensor, and infrared (IR) proximity sensor.

Alternatively, the proximity sensor may be in the form of a transceiver arrangement which includes a transmitter located on and/or within the housing and/or at the reference point and receiver located on and/or within the housing and/or at the reference point, respectively. The transmitter may be configured to transmit data to the receiver allowing a proximity therebetween to be determined. The transmitter and/or receiver may further be configured to activate the deterring means if no data is transmitted therebetween. The data may be in the form of encrypted data which is configured to be decrypted by the receiver to allow the receiver to interpret the data and to inhibit a third party from replicating the data and transmitting the replicated data to the receiver to inhibit activation of the deterring means if the transmitter has been deactivated. The encrypted data may be in the form of a unique data packet associated with a specific cell arrangement. The transmitter may be configured to communicate with the receiver via any suitable communication system of the group including radio, Bluetooth, Bluetooth Low Energy (BLE), Wi-Fi, Zigby, infrared, cellular network, 3G, 4G, 5G, satellite communication, preferably being configured to communicate via BLE. The transmitter may be in the form of a BLE beacon.

The motion sensor may be configured to sense motion of and therefore, the presence of, an object in the form of an article, limb or digit, within the housing, typically when the object is inserted into the housing, typically during an attempt to gain access to the housing to remove the cell arrangement from the housing. The motion sensor may be located on the lid portion, preferably an inner surface thereof, and/or on the wall and/or a base of the housing, preferably an inner surface thereof. The motion sensor may be selected from the group including a passive infrared (PIR) sensor, microwave (MW) sensor, and dual technology motion sensor.

A controller may be provided for controlling the deterring means. The controller may be arranged in electrical communication with the sensor arrangement and deterring means in order to activate the deterring means when tampering with the housing and/or cell arrangement is sensed, typically upon the occurrence of any one or more of the group including heat being applied to the housing and/or cell arrangement, displacement of the housing and/or cell arrangement, the proximity sensed by the proximity sensor exceeding a predetermined limit, and motion being detected within the housing. The controller may be housed within the housing. The receiver may form part of the controller for controlling operation of the deterring means.

A transceiver arrangement housing may be provided for housing the transceiver arrangement therein, preferably for housing the transmitter of the transceiver arrangement therein. The transceiver arrangement housing may include a transceiver sensor arrangement for sensing tampering with the transceiver arrangement housing and/or transmitter. The transceiver sensor arrangement may include any one or more of the group including a heat sensor, opening sensor, displacement sensor, proximity sensor, and motion sensor as hereinbefore described.

The deterring means may include a deactivation means which may be configured to deactivate, either temporarily or permanently, the cell arrangement when tampering with the housing, transceiver arrangement housing and/or cell arrangement is sensed by the sensor arrangement and/or transceiver sensor arrangement. The deactivation means may be configured to erase data which may be stored on a cell management computing device. The deactivation means may be arranged in electrical communication with the cell arrangement for inhibiting electrical communication between one or more cells thereof, thereby inhibiting the cell arrangement from powering a device. Alternatively, the deactivation means may be arranged in electrical communication with a positive and negative terminal of the cell arrangement and/or one or more cells allowing the deactivation means to create a short circuit between the terminals causing drainage of the cell arrangement and/or one or more cells inhibiting the cell arrangement from powering a device, typically being in the form of the cell tower. The deactivation means may be in the form of a relay of the group including a coaxial relay, contactor, force-guided contacts relay, latching relay, machine tool relay, mercury relay, mercury-wetted relay, multi-voltage relay, overload protection relay, polarized relay, reed relay, safety relays, solid-state contactor, solid-state relay, static relay, time delay relay, and vacuum relay.

The deterring means may further include a warning device which may be arranged in electrical communication with the sensor arrangement and/or controller to generate a warning when the sensor arrangement senses that the housing and/or cell arrangement is being tampered with. The warning device may be configured to generate and audible and/or visual warning. The warning device may be in the form of any one or more of the group including a buzzer, alarm, lighting device, and siren. The warning device may be further configured to generate a warning when the receiver of the transceiver arrangement does not receive data from the transmitter of the transceiver arrangement or when the transceiver sensor arrangement senses that the transceiver arrangement housing and/or transceiver arrangement is being tampered with.

The deterring means may yet further include a deterrent releasing device for releasing a deterrent when the sensor arrangement senses that the housing, cell arrangement and/or the transceiver arrangement housing is being tampered with. The deterrent may be in the form of any one or more of the group including a paint, dye, smoke and pepper spray. The deterrent releasing device may be further configured to release a deterrent when the receiver does not receive data from the transmitter or when the transmitter sensor arrangement senses that the transmitter housing and/or transmitter is being tampered with.

The deterring means may even further include an output reduction means for reducing the output of the cell arrangement under predetermined circumstances. The predetermined circumstances may include sensing, by the sensor arrangement, tampering of the housing and/or cell arrangement. Alternatively, in the event that the cell arrangement is in the form of a vehicle battery, the output reduction means may be configured to reduce the output of the cell arrangement when a remote transmitter is not within a predetermined range. The remote transmitter may be configured to transmit signals via any suitable electromagnetic frequency including Bluetooth, Wi-Fi or Zigby, preferably being configured to transmit signals via Bluetooth. The output reduction means may be configured to reduce the output to zero, or to a degree sufficient to inhibit starting of an engine of a vehicle to which the cell arrangement is connected.

A status indication device may be provided for indicating a status of the cell arrangement and/or housing to a third party, typically being the service provider. The status indication device may be arranged in communication with the controller, sensor arrangement, and/or transceiver sensor arrangement to allow the status to be communicated to the status indication device when tampering is sensed by the sensor and transceiver sensor arrangements. The status may be configured to indicate if tampering with the housing and/or cell arrangement was sensed by the sensor arrangement. The status indication device may be further configured to indicate the status of the transceiver arrangement to the third party. The status may be further configured to indicate when the receiver does not receive data from the transmitter or when the transmitter sensor arrangement senses that the transmitter housing and/or transmitter is being tampered with. The status indication device may be configured to communicate with the controller, sensor arrangement, and/or transceiver sensor arrangement via any suitable communication system of the group including radio, Bluetooth, Bluetooth Low Energy (BLE), Wi-Fi, Zigby, infrared, cellular network, 3G, 4G, 5G, and satellite communication. The status indication device may be in the form of a conventional computing device of the group including a smart phone, smart watch, tablet, laptop, desktop computer and remote server.

According to a second aspect of the invention, there is provided an anti-tampering device including: —

a sensor arrangement for sensing a proximity of a remote transmitter;

an output controller arranged in electrical communication with the sensor arrangement and a cell arrangement, for controlling the output of the cell arrangement according to the sensed proximity of the remote transmitter.

The sensor arrangement may be in the form of any suitable sensor arrangement capable of sensing the proximity of the remote transmitter. Preferably, the sensor arrangement may be configured to communicate with, and therefore sense the proximity of, the remote transmitter, via any suitable electromagnetic frequency including Bluetooth, Wi-Fi, and Zigby, preferably via Bluetooth. The remote transmitter may be in the form of a Bluetooth transmitter or dongle.

The cell arrangement may be in the form of a battery for a vehicle.

The output controller may be configured to reduce the output of the cell arrangement when the proximity sensed by the sensor arrangement exceeds a predetermined value or distance. The predetermined value or distance may be in the range of 1m to 10m. More particularly, the output controller may be configured to reduce the output of the cell arrangement such that the output thereof is insufficient to start an engine of the vehicle.

### BRIEF DESCRIPTION OF THE DRAWINGS

An anti-tampering device in accordance with the invention will now be described by way of the following, non-limiting examples with reference to the accompanying drawings.

In the drawings: —

FIG. 1 is a schematic showing a diagram of an anti-tampering device in accordance with the present invention; and

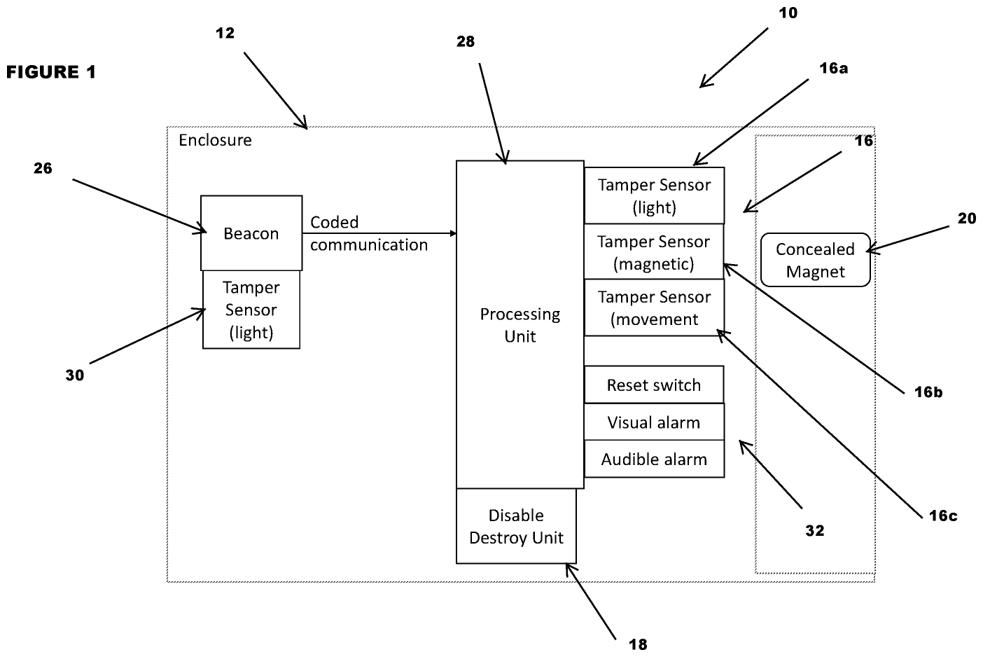

FIG. 2 is a schematic showing a circuit diagram of the anti-tampering device as shown in FIG. 1.

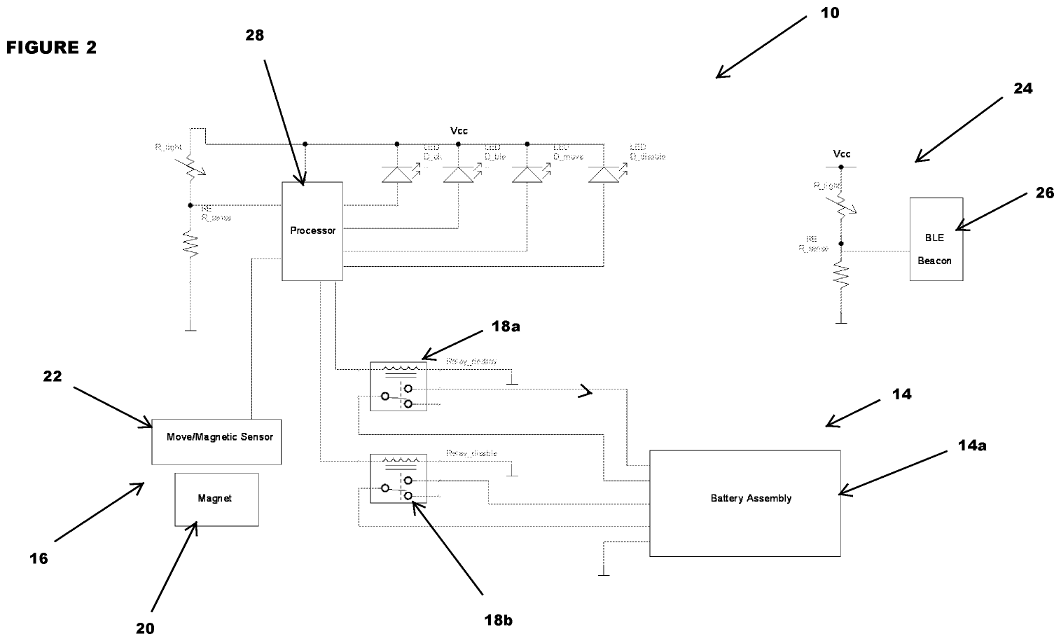

### DETAILED DESCRIPTION OF THE INVENTION

Referring now to the drawings reference numeral 10 refers generally to an anti-tampering device including a housing 12 for housing a cell arrangement 14, a sensor arrangement 16 mounted on the housing 12 for sensing tampering with the housing 12, and a deterring means 18 arranged in communication with the sensor arrangement 16 and configured to activate when tampering is sensed by the sensor arrangement 16 in order to deter tampering with the housing and/or cell arrangement.

The housing 12 includes a container portion (not shown) and a lid portion (not shown) for allowing the container portion (not shown) to be closed. The container portion (not shown) is sized, shaped and configured to receive the cell arrangement 14 complementally therein. The container portion (not shown) is further sized, shaped and configured to house the sensor arrangement 16 and deterring means 18 therein. The lid portion (not shown) is displaceably secured to the housing 12 via a hinge arrangement, screws, adhesive or a latch arrangement. Typically, the lid portion (not shown) is in the form of a hinged cover which is secured to the container portion (not shown) via a lockable latch arrangement (not shown). The housing 12 is manufactured form any suitable plastics or metallics material.

The cell arrangement 14 includes a plurality of cells (not shown) which are arranged in a series or parallel configuration to form a battery 14a. The battery 14a is in the form of a lead acid battery or lithium battery. The battery 14a is typically chosen to be capable of powering any electronic equipment, device or components (not shown) which are utilised in any one of the group including a computing device, computing system, motor vehicle including a car, truck, motorbike and motorboat, and telecommunication instrumentation (not shown). In one form of the invention, the cell arrangement 14 is in the form of a battery capable of powering electronic equipment utilised in telecommunication instrumentation which is mounted on telecommunication tower structures (not shown). In another form of the invention, the cell arrangement 14 is in the form of a battery for a motor vehicle (not shown). The battery 14a has any suitable voltage required for powering particular electronic equipment, devices or components (not shown). The battery 14a has any suitable voltage in the range of 2 to 48V, typically varying according to the voltage requirement of the device to be powered.

The sensor arrangement 16 is mounted on the housing 12, typically being mounted within the housing 12 for sensing tampering therewith. The sensor arrangement 16 includes any one or more of the group including a heat sensor (not shown) for sensing hear applied to the housing, opening sensor 16a, 16b, for sensing opening of the housing, displacement sensor (not shown) for sensing relative displacement of the housing, proximity sensor (not shown) for sensing proximity of the housing relative a reference point, and motion sensor 16c for sensing motion of an object within the housing. The sensor arrangement 16 is configured to activate the deterring means 18 when tampering is sensed.

The heat sensor (not shown) is configured to sense heat applied to the housing 12, typically heat applied in an attempt to compromise the structural integrity of the housing 12 to facilitate removal and theft of the cell arrangement 14. The heat sensor (not shown) is arranged within the housing 12, typically being mounted on an inner wall (not shown) thereof.

The opening sensor 16a, 16b is configured to sense when the lid portion (not shown) of the housing 12 is opened or removed from the housing 12. The opening sensor 16a, 16b is located on the lid portion (not shown), typically on an inner surface (not shown) thereof, or on a wall (not shown) or a base (not shown) of the container portion (not shown) of the housing 12, typically an inner surface (not shown) thereof. The opening sensor 16a, 16b is in the form of a light sensor 16a for sensing light entering the housing, typically when the lid portion (not shown) is opened or removed from the housing 12 during daylight or when a lighting device (not shown), typically a torch or the like, is used to light up an inside of the housing 12 during the night. The light sensor 16a is selected from the group including a photoresistor, photodiode, and phototransistor. Alternatively, the opening sensor 16a, 16b is in the form of a magnetic sensor arrangement 16b which may be arranged on opposing abutting edge regions (not shown) of the lid and container portions (not shown) of the housing 12. In particular, the magnetic sensor arrangement 16b is configured to sense the absence of a magnetic field (not shown) when the lid potion (not shown) is opened or removed from the container portion (not shown) of the housing 12. More particularly, the magnetic sensor arrangement 16b includes a magnetic element 20 and a magnetic sensor 22 which is arranged on the lid portion (not shown), typically an inner edge region (not shown) thereof, or on the wall (not shown) and or base (not shown) of the container portion (not shown) of the housing 12, typically an inner edge region (not shown) thereof, respectively. The magnetic sensor 22 is selected from the group including a giant magnetoresistance (GMR) sensor, hall sensor, and reed switch.

The displacement sensor (not shown) is configured to sense displacement of the housing 12 or cell arrangement 14 relative a support surface (not shown), typically being a ground surface or base plate (not shown). The displacement sensor (not shown) is located on a surface (not shown) of the housing 12, typically an inner surface (not shown) thereof, or a surface (not shown) of the cell arrangement 14, typically an outer surface (not shown) thereof. The displacement sensor (not shown) is in the form of any one or more of the group including an accelerometer, gyroscope, magnetometer, impact sensor, shock sensor, and vibration sensor.

The proximity sensor (not shown) is configured to sense a proximity of the housing 12 or cell arrangement relative to the reference point (not shown). The reference point (not shown) is defined by the location of the proximity sensor (not shown). Alternatively, the reference point (not shown) is defined by a surface (not shown) sensed by the proximity sensor (not shown). The proximity sensor (not shown) is mounted on the housing 12 and orientated to face and sense a particular surface (not shown) in the vicinity of the housing 12. Alternatively, the proximity sensor (not shown) is mounted on a support surface (not shown) in the vicinity of the housing 12 and orientated to face and sense a surface (not shown) of the housing 12. More particularly, the support surface can form part of any fixed surface located in the vicinity of the housing 12 or cell arrangement 14. The support surface (not shown) forms part of the telecommunication tower structure (not shown) on which telecommunication instrumentation (not shown) being powered by the cell arrangement 14 is mounted. Alternatively, and although not shown, the support surface can form part of any component or structural element (not shown) of a vehicle (not shown) which is located in the vicinity of the housing 12 or cell arrangement 14. In particular, the proximity sensor (not shown) is configured to sense when a proximity of the housing 12 or cell arrangement 14 to the reference point (not shown) exceeds a desired distance (not shown). The desired distance (not shown) is set according to the preferences of a user (not shown), typically being set according to the preferences of the telecommunication network service provider. The proximity sensor (not shown) is located on the surface (not shown) of the housing 12, typically the inner surface (not shown) thereof, or surface (not shown) of the cell arrangement 14, typically the outer surface (not shown) thereof. The proximity sensor (not shown) is in the form of any one or more of the group including a conductive proximity sensor, capacitive proximity sensor, ultrasonic proximity sensor, and infrared (IR) proximity sensor.

Alternatively, the proximity sensor is in the form of a transceiver arrangement 24 which includes a transmitter 26 located on or within the housing or at the specific reference location (not shown) and receiver (not shown) located on or within the housing 12 or at the reference point (not shown), respectively. The transmitter 26 is configured to transmit data (not shown) to the receiver (not shown) allowing a proximity therebetween to be determined. The transmitter 26 or receiver (not shown) is further configured to activate the deterring means 18 if no data (not shown) is transmitted therebetween. The data (not shown) is in the form of encrypted data (not shown) which is configured to be decrypted by the receiver (not shown) to allow the receiver (not shown) to interpret the data (not shown) and to inhibit a third party (not shown) from replicating the data (not shown) and transmitting the replicated data (not shown) to the receiver (not shown) to inhibit activation of the deterring means 18 if the transmitter 26 has been deactivated. The encrypted data (not shown) is in the form of a unique data packet (not shown) associated with a specific cell arrangement 14. The transmitter 26 is configured to communicate with the receiver (not shown) via any suitable communication system of the group including radio, Bluetooth, Bluetooth Low Energy (BLE), Wi-Fi, Zigby, infrared, cellular network, 3G, 4G, 5G, satellite communication, typically being configured to communicate via BLE. The transmitter 26 is in the form of a BLE beacon.

The motion sensor 16c is configured to sense motion of and therefore, the presence of, an object in the form of an article, limb or digit, within the housing 12, typically when the object (not shown) is inserted into the housing 12, typically during an attempt to gain access to the housing 12 in order to remove the cell arrangement 14 from the housing 12. The motion sensor 16c is located on the lid portion (not shown), typically an inner surface (not shown) thereof, or on the wall (not shown) or a base (not shown) of the housing 12, typically an inner surface (not shown) thereof. The motion sensor 16c is selected from the group including a passive infrared (PIR) sensor, microwave (MW) sensor, and dual technology motion sensor.

A controller 28 is provided for controlling the deterring means 18. The controller 28 is arranged in electrical communication with the sensor arrangement 16 and deterring means 18 in order to activate the deterring means 18 when tampering with the housing 12 or cell arrangement 14 is sensed, typically upon the occurrence of any one or more of the group including heat being applied to the housing 12 or cell arrangement 14, displacement of the housing 12 or cell arrangement 14, the proximity sensed by the proximity sensor (not shown) exceeding a predetermined limit, and motion being detected within the housing 12. The controller 28 is housed within the housing 12. The receiver (not shown) forms part of the controller 28 for controlling operation of the deterring means 18.

A transceiver arrangement housing (not shown) is provided for housing the transceiver arrangement 24 therein, typically for housing the transmitter 26 of the transceiver arrangement 24 therein. The transceiver arrangement housing (not shown) includes a transceiver sensor arrangement 30 for sensing tampering with the transceiver arrangement housing (not shown) or transmitter 26. The transceiver sensor arrangement 30 includes any one or more of the group including a heat sensor, opening sensor, displacement sensor, proximity sensor, and motion sensor as hereinbefore described.

The deterring means 18 includes a deactivation means 18a, 18b which is configured to deactivate, either temporarily or permanently, the cell arrangement 14 when tampering with the housing 12, transceiver arrangement housing (not shown) or cell arrangement 14 is sensed by the sensor arrangement 16 or transceiver sensor arrangement 30. The deactivation means is configured to erase data stored on a cell management computing device. The deactivation means 18a, 18b is arranged in electrical communication with the cell arrangement 14 for inhibiting electrical communication between one or more cells (not shown) thereof, thereby inhibiting the cell arrangement 14 from powering a device (not shown). Alternatively, the deactivation means 18a, 18b is arranged in electrical communication with a positive and negative terminal of the cell arrangement (not shown) or one or more cells (not shown) allowing the deactivation means 18a, 18b to create a short circuit between the terminals causing drainage of the cell arrangement 14 or one or more cells (not shown) inhibiting the cell arrangement 14 from powering a device (not shown), typically being in the form of the cell tower (not shown). The deactivation means 18a, 18b is in the form of a relay of the group including a coaxial relay, contactor, force-guided contacts relay, latching relay, machine tool relay, mercury relay, mercury-wetted relay, multi-voltage relay, overload protection relay, polarized relay, reed relay, safety relays, solid-state contactor, solid-state relay, static relay, time delay relay, and vacuum relay.

The deterring means 18 further includes a warning device 32 which is arranged in electrical communication with the sensor arrangement 16 or controller 28 to generate a warning when the sensor arrangement 16 senses that the housing 12 or cell arrangement 14 is being tampered with. The warning device 32 is configured to generate and audible or visual warning. The warning device 32 is in the form of any one or more of the group including a buzzer, alarm, lighting device, and siren. The warning device 32 is further configured to generate a warning when the receiver (not shown) of the transceiver arrangement 24 does not receive data (not shown) from the transmitter 26 of the transceiver arrangement 24 or when the transceiver sensor arrangement 30 senses that the transceiver arrangement housing (not shown) or transceiver arrangement 24 is being tampered with.

The deterring means 18 further includes a deterrent releasing device (not shown) for releasing a deterrent (not shown) when the sensor arrangement 16 senses that the housing 12, cell arrangement 14, or transceiver arrangement housing (not shown) is being tampered with. The deterrent (not shown) is in the form of any one or more of the group including a paint, dye, smoke and pepper spray. The deterrent releasing device (not shown) is further configured to release a deterrent (not shown) when the receiver (not shown) does not receive data (not shown) from the transmitter 26 or when the transmitter sensor arrangement 30 senses that the transmitter housing (not shown) or transmitter 26 is being tampered with.

Although not shown, the deterring means 18 even further includes an output reduction means (not shown) for reducing the output of the cell arrangement 14 under predetermined circumstances. The predetermined circumstances include sensing, by the sensor arrangement 16, tampering of the housing 12 or cell arrangement 14. Alternatively, in the event that the cell arrangement 14 is in the form of a vehicle battery, the output reduction means (not shown) is configured to reduce the output of the cell arrangement 14 when a remote transmitter (not shown) is not within a predetermined range. The remote transmitter (not shown) is configured to transmit signals via any suitable electromagnetic frequency including Bluetooth, Wi-Fi or Zigby, typically being configured to transmit signals via Bluetooth. The output reduction means (not shown) is configured to reduce the output to zero, or to a degree sufficient to inhibit starting of an engine (not shown) of a vehicle (not shown) to which the cell arrangement 14 is connected.

A status indication device (not shown) is provided for indicating a status (not shown) of the cell arrangement 14 or housing 12 to a third party (not shown), typically being the service provider. The status indication device (not shown) is arranged in communication with the controller 28, sensor arrangement 16, or transceiver sensor arrangement 30 to allow the status to be communicated to the status indication device (not shown) when tampering is sensed by the sensor and transceiver sensor arrangements 16, 30. The status (not shown) is configured to indicate if tampering with the housing 12 or cell arrangement 14 was sensed by the sensor arrangement 16. The status indication device (not shown) is further configured to indicate the status (not shown) of the transceiver arrangement 24 to the third party (not shown). The status (not shown) is further configured to indicate when the receiver (not shown) does not receive data (not shown) from the transmitter 26 or when the transmitter sensor arrangement 30 senses that the transmitter housing (not shown) or transmitter 26 is being tampered with. The status indication device (not shown) is configured to communicate with the controller 28, sensor arrangement 16, or transceiver sensor arrangement 30 via any suitable communication system of the group including radio, Bluetooth, Bluetooth Low Energy (BLE), Wi-Fi, Zigby, infrared, cellular network, 3G, 4G, 5G, and satellite communication. The status indication device (not shown) is in the form of a conventional computing device of the group including a smart phone, smart watch, tablet, laptop, desktop computer and remote server.

In use, for example, when a person (not shown) attempts to remove the cell arrangement 14 from the housing 12 by opening the lid portion (not shown) thereof, the opening sensor 16a senses tampering with the housing 12 and the deterring means 18 is activated. Once the deterring means 18 is activated the warning device generates an audible or visual warning (not shown), the deactivation device 18a, 18b deactivates the cell arrangement 14, rendering it useless and the deterrent releasing device (not shown) releases a deterrent (not shown) in the form of pepper spray in an attempt to inhibit the person from removing the cell arrangement 14.

Although not shown in the Figures, in an alternative embodiment of the present invention, there is provided an anti-tampering device including a sensor arrangement for sensing a proximity of a remote transmitter and an output controller arranged in electrical communication with the sensor arrangement and a cell arrangement, for controlling the output of the cell arrangement according to the sensed proximity of the remote transmitter.

The sensor arrangement is in the form of any suitable sensor arrangement capable of sensing the proximity of the remote transmitter. Typically, the sensor arrangement 16 is configured to communicate with, and therefore sense the proximity of, the remote transmitter (not shown), via any suitable electromagnetic frequency including Bluetooth, Wi-Fi, and Zigby, typically via Bluetooth, the remote transmitter typically being in the form of a Bluetooth transmitter or dongle.

The cell arrangement 14 is in the form of a battery (not shown) for a vehicle (not shown).

The output controller is configured to reduce the output of the cell arrangement when the proximity sensed by the sensor arrangement exceeds a predetermined value or distance. The predetermined value or distance is in the range of 1 m to 10m. More particularly, the output controller is configured to reduce the output of the cell arrangement such that the output thereof is insufficient to start an engine of the vehicle.

In use, where an attempt is made to steal a vehicle in which the anti-tampering device is installed, a thief would enter the vehicle and attempt to start the engine thereof without being aware of the required Bluetooth connection between the sensor arrangement and the remote Bluetooth transmitter, which would potentially be located with the vehicle owner. In such a case, where the corresponding Bluetooth transmitter is located with the vehicle owner, the output of the battery is limited such that insufficient power is available to start the engine thus preventing the thief from being able to start the engine and successfully steal the vehicle.

It is, of course, to be appreciated that the anti-tampering device in accordance with the invention is not limited to the precise constructional and functional details as hereinbefore described with reference to the accompanying drawings and which is varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

The inventor believes that the anti-tampering device in accordance with the present invention is advantageous in that it activates the deterring means when tampering with the housing is sensed by the sensor arrangement. The invention is further advantageous in that the sensor arrangement includes many different forms of sensors which are configured to sense many different forms of tampering to make it more difficult for a person to attempt to remove the cell arrangement from the housing or specific location. The invention is also advantageous in that it allows the cell arrangement to be deactivated when tampering is sensed by the sensor arrangement thus rendering the cell arrangement useless to the person who attempted to steal it.

1. An anti-tampering device including:
a housing for a battery;
a sensor arrangement mounted within the housing for sensing tampering therewith; and
a deterring means arranged in communication with the sensor arrangement for deterring use of the cell arrangement when tampering is sensed by the sensor arrangement.

2.-5. (canceled)

6. An anti-tampering device as claimed in claim 1 wherein the battery is capable of powering any electronic equipment, device or components utilised in any one of the group including but not limited to a computing device, computing system, motored vehicle, and telecommunication instrumentation.

7. (canceled)

8. An anti-tampering device as claimed in claim 1 wherein the sensor arrangement includes any one or more of the group including a heat sensor for sensing heat applied to the housing, opening sensor for sensing opening of the housing, displacement sensor for sensing relative displacement of the housing, proximity sensor for sensing a proximity of the housing relative a reference point, and motion sensor for sensing motion of an object within the housing.

9. An anti-tampering device as claimed in claim 3 wherein the opening sensor is configured to sense when the a lid portion of the housing is opened or removed from the housing.

10. An anti-tampering device as claimed in claim 4 wherein the opening sensor is in the form of a light sensor for sensing light entering the housing.

11. (canceled)

12. An anti-tampering device as claimed in claim 3 wherein the opening sensor is in the form of a magnetic sensor arrangement which is arranged on opposing abutting edge regions of the-lid portion and a container portions of the housing.

13. (canceled)

14. An anti-tampering device as claimed in claim 3 wherein the displacement sensor is configured to sense displacement of the housing or battery relative a support surface.

15. (canceled)

16. An anti-tampering device as claimed in claim 3 wherein the proximity sensor is configured to sense a proximity of the housing or battery relative the reference point, wherein the proximity sensor is mounted on a support surface in the vicinity of the housing and orientated to face and sense a surface of the housing.

17.-23. (canceled)

24. An anti-tampering device as claimed in claim 3 wherein the proximity sensor is in the form of a transceiver arrangement which includes a transmitter located within the housing or at the reference point and a receiver located within the housing or at the reference point, respectively,
wherein the transmitter is configured to transmit data to the receiver allowing a proximity therebetween to be determined, and
wherein the proximity sensor is configured to activate the deterring means if no data is transmitted therebetween.

25.-26. (canceled)

27. An anti-tampering device as claimed in claim 9 wherein the data is in the form of encrypted data which is configured to be decrypted by the receiver to allow the receiver to interpret the data and to inhibit a third party from replicating the data and transmitting the replicated data to the receiver to inhibit activation of the deterring means if the transmitter has been deactivated.

28. An anti-tampering device as claimed in claim 10 wherein the encrypted data is in the form of a unique data packet associated with a specific battery.

29. An anti-tampering device as claimed in claim 11 wherein the transmitter is configured to communicate with the receiver via any suitable communication system of the group including radio, Bluetooth, Bluetooth Low Energy (BLE), Wi-Fi, Zigby, infrared, cellular network, 3G, 4G, 5G, and satellite communication.

30.-33. (canceled)

34. An anti-tampering device as claimed in claim 9 wherein a transceiver arrangement housing is provided for housing the transmitter of the transceiver arrangement therein,
wherein the transceiver arrangement housing includes a transceiver sensor arrangement for sensing tampering with the transceiver arrangement housing, and
wherein the transceiver sensor arrangement includes any one or more of the group including a heat sensor, opening sensor, displacement sensor, proximity sensor, and motion sensor.

35.-36. (canceled)

37. An anti-tampering device as claimed in claim 1 wherein the deterring means includes a deactivation means which is configured to deactivate the battery when tampering with the housing or battery is sensed by the sensor arrangement and/or transceiver sensor arrangement.

38. (canceled)

39. An anti-tampering device as claimed in claim 14 wherein the deactivation means is configured to deactivate the battery permanently.

40. (canceled)

41. An anti-tampering device as claimed in claim 1 wherein the deterring means includes a warning device which is arranged in electrical communication with the sensor arrangement to generate a warning when the sensor arrangement senses that the housing or battery is being tampered with.

42. (canceled)

43. An anti-tampering device as claimed in claim 1 wherein the deterring means includes a deterrent releasing device for releasing a deterrent when the sensor arrangement senses that the housing or battery is being tampered with.

44. An anti-tampering device as claimed in claim 17 wherein the deterrent is in the form of any one or more of the group including a paint, dye, smoke and pepper spray.

45. (canceled)

46. An anti-tampering device as claimed in claim 1 wherein the deterring means includes an output reduction means for reducing the output of the cell arrangement under predetermined conditions.

47.-49. (canceled)

50. An anti-tampering device including:
a sensor arrangement for sensing a proximity of a remote transmitter;
an output controller arranged in electrical communication with the sensor arrangement and a battery for controlling the output of the battery according to the sensed proximity of the remote transmitter.

51.-53. (canceled)
